(19) United States
(12) Patent Application Publication
(10) Pub. No.: US 2021/0262506 A1
(43) Pub. Date: Aug. 26, 2021

(54) IMPROVEMENTS IN FASTENING DEVICES

(71) Applicant: TITUS D.O.O. DEKANI, Dekani (SI)

(72) Inventor: Robert Lukezic, Portoroz (SI)

(21) Appl. No.: 17/059,855

(22) PCT Filed: Jun. 25, 2019
(86) PCT No.: PCT/EP2019/066784

§ 371 Date: Nov. 30, 2020

(30) Foreign Application Priority Data
Jun. 28, 2018 (GB) 1810630.2

(51) Int. Cl. F16B 12/20; F16B 13/06

(52) U.S. Cl. CPC F16B 12/2036; F16B 2012/103; F16B 13/065

(57) ABSTRACT

A fastening device is provided for forming a joint between two edge to edge panels arranged to either side of a central panel. The fastening device is of the kind including an elongate dowel and a sleeve, with the dowel having a head at one end, an expander at the other end and a shank extending between the two. The expander co-operates with an expandable region of the sleeve to cause the expandable region to expand radially outwardly upon relative axial movement between the dowel and sleeve. The expandable region of the sleeve is arranged to expand in a non-uniform manner, with a greater degree of expansion being caused at a free end of the sleeve.

### BACKGROUND

Fastening devices may be used for furniture and other applications.

### SUMMARY

The invention provides a fastening device for a joint between two members, of the kind comprising an elongate dowel and a sleeve, with the dowel having a head at one end, an expander at the other end and a shank extending therebetween, with the expander co-operating with an expandable region of the sleeve to cause it to expand radially outwardly upon relative axial movement between the dowel and sleeve, wherein the expandable region of the sleeve is arranged to expand in a non-uniform manner, with a greater degree of expansion being caused at a free end of the sleeve.

By way of example, embodiments of the invention will now be described with reference to the accompanying drawings, in which:

### BRIEF DESCRIPTION OF THE DRAWINGS

FIG. 1 shows a form of fastening device according to embodiments of the invention,

FIG. 2 shows a form of tightening device according to embodiments of the invention,

FIG. 3 shows the fastening device of FIG. 1 in a form of back-to-back panel joint according to embodiments of the invention,

FIG. 4 is a sectional view through the joint of FIG. 3 according to embodiments of the invention, and

FIGS. 5a and 5b are enlarged details from the FIG. 4 sectional view showing the fastening device in pre-tightened and tightened conditions according to embodiments of the invention.

### DETAILED DESCRIPTION

Specific embodiments of the disclosed technology will now be described in detail with reference to the accompanying figures. Like elements in the various figures may be denoted by like reference numerals and/or like names for consistency.

The following detailed description is merely exemplary in nature, and is not intended to limit the disclosed technology or the application and uses of the disclosed technology. Furthermore, there is no intention to be bound by any expressed or implied theory presented in the preceding technical field, background, brief summary or the following detailed description.

In the following detailed description of embodiments of the disclosed technology, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

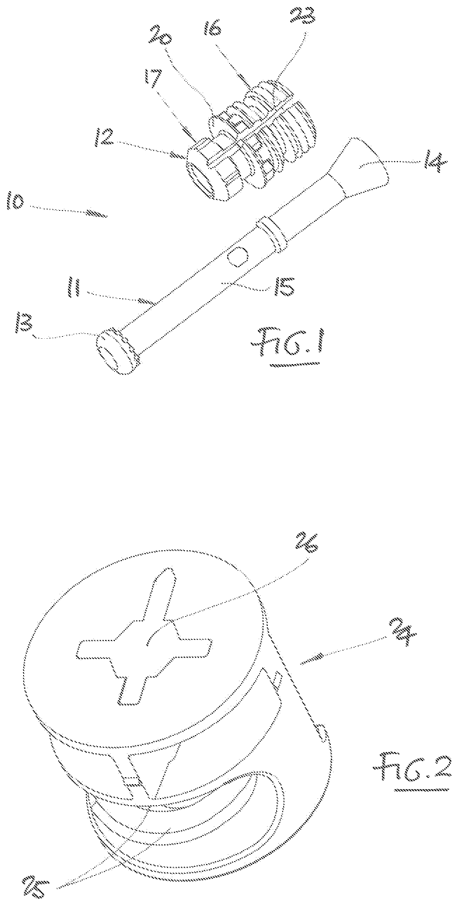

The fastening device 10 seen in FIG. 1 is for forming a joint between panels, e.g. in a piece of furniture. In particular, the device 10 is for fastening panels together in a so called back-to-back joint, as will be described in more detail below.

The fastening device 10 comprises an elongate dowel 11 and a sleeve 12. The dowel 11 is of circular cross-section, with a head 13 at one end, an expander 14 at the other end and a shank 15 extending therebetween. The dowel 11 is conveniently made of metal, such as cast zinc or rolled steel. The sleeve 12 is conveniently made of plastics material.

The sleeve 12 is arranged on the end of the dowel 11 over the expander 14. The sleeve 12 may conveniently be formed around the dowel 11 in an insert moulding process. Another option would be to form the sleeve 12 separately in semi-cylindrical parts which fit together around the dowel 11.

The sleeve 12 has a stepped outer profile, with an expandable region 16 at one end and a reduced diameter portion 17 at the other end. The expandable region 16 of the sleeve 12 fits over the expander 14 of the dowel 11 and is designed to be a push fit in a mounting hole 18 in the face of a first panel C where it is to be anchored. The reduced diameter portion 17 of the sleeve 12 fits over the shank 15 of the dowel 11 and is designed to be a clearance fit in a mounting hole 19a, 19b in the edge of a second panel A, B. The interface between the two end sections 16, 17 of the sleeve 12 creates an annular shoulder 20. This acts as a reaction surface against the edge of the second panel A, B in use, as will be described below.

The expander 14 is of conical form, as seen in FIG. 1, extending from the shank 15 of the dowel 11. The sleeve 12 has a bore that is configured to conform with the dowel profile, in that it has a plain portion 21 to receive the shank 15 and a conical portion 22 to receive the expander 14. In known manner, the expander 14 is designed to force the expandable region 16 to expand radially outwardly when the dowel 11 is pulled into the sleeve 12. The expandable region 16 is provided with a number of axially extending slits 23 to facilitate this expansion process.

The action of pulling the dowel 11 into sleeve 12 is achieved via the engagement of its head 13 with a tightening device, such as the rotatable cam 24 as seen in FIG. 2, with the shoulder 20 acting as a reaction surface against the edge of the panel A, B in which the cam is mounted. The cam 24 is of a typically known generally cylindrical form, with a pair of spaced apart arcuate camming surfaces 25 to engage the head 13 of the dowel 12 and cause its axial displacement when the cam is rotated. The cam 22 is rotatable by engagement of a tool such as a screwdriver in a drive formation 26.

A typical form of back-to-back joint between panels is seen in FIG. 3. In this, panels A and B lying in the same plane are to be attached to either side of a central panel C lying perpendicular to this plane. Cams 24a, 24b are rotatably mounted in respective panels A, B to be operable to tighten respective fastening devices 10a, 10b into engagement with the central panel C.

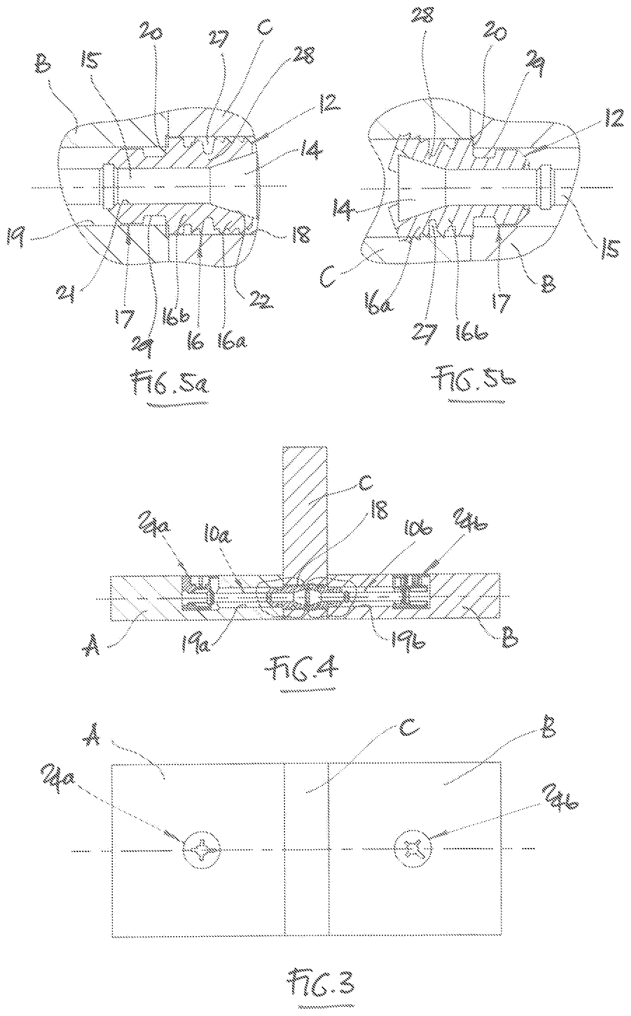

Furniture panels typically tend to be prepared with mounting holes for their jointing devices pre-drilled according to standard patterns. In a back-to-back joint, this means that the jointing devices will typically be in opposing alignment, as can be seen in FIG. 3. As a result of this, the two opposing fastening devices 10a, 10b are required to be anchored in the same mounting hole 18 in the central panel C, as can be seen in FIG. 4. What this means in practice is that effectively only half the depth of the central panel C is available for achieving anchorage of each fastening device 10a, 10b. The sleeve 12 here is of a special design for this purpose.

The sleeve 12 is provided with a groove 27 extending around its outer circumference in the central area of its expandable region 16. This divides the expandable region 16 into two separate sections 16a, 16b, and because these are connected by only a relatively small web of material 28, the two separate sections are effectively able to expand independently of each other. What this means in practice is that the groove 27 will allow the free end section 16a of the expandable region 16 to effectively hinge about the small web of material 28 and thus expand more than the other section 16b. The arrangement is designed to ensure that outward expansion of the expandable region 16 of the sleeve 12 will be greatest at its free end section 16a. This non-uniform expansion of the expandable region 16 of the sleeve 12 will help to concentrate the forces anchoring the fastening device at a position as deep in the panel C as possible. This is an important consideration, given that only half the panel depth is available for anchoring the fastening device in a joint of this nature.

A further feature of the sleeve design here is that the reduced diameter portion 17 has an undercut 29 adjacent to the annular shoulder 20. This helps to ensure that the reduced diameter portion 17 of the sleeve 12 is able to be received fully home within its mounting hole 19 in the panel A, B. It also allows additional flexure of the sleeve 12 when the device is tightened, which has been found to increase the pull-out strength of the joint.

Although the fastening device described above has been developed with back-to-back joints specifically in mind, it will be appreciated that it is equally effective for use in other joints.

While the disclosed technology has been described with respect to a limited number of embodiments, those skilled in the art, having benefit of this disclosed technology, will appreciate that other embodiments can be devised which do not depart from the scope of the disclosed technology as disclosed herein. Accordingly, the scope of the disclosed technology should be limited only by the attached claims.

1. A fastening device for a joint between two members, the fastening device comprising an elongate dowel and a sleeve, with the dowel having a head at one end, an expander at the other end and a shank extending therebetween, with the expander co-operating with an expandable region of the sleeve to cause the expandable region to expand radially outwardly upon relative axial movement between the dowel and sleeve, wherein the expandable region of the sleeve is arranged to expand in a non-uniform manner, with a greater degree of expansion being caused at a free end of the sleeve.

2. A fastening device as claimed in claim 1 wherein the sleeve has a circumferentially extending groove which divides the expandable region into two sections that are effectively independently expandable.

3. A fastening device as claimed in claim 2 wherein the section of the expandable region that is at the free end of the sleeve expands in a hinging motion relative to its neighbouring section.

4. A fastening device as claimed in claim 1 wherein the expandable region of the sleeve is provided with one or more axially extending slits to facilitate expansion.

5. A fastening device as claimed in claim 1 wherein the sleeve further comprises an annular shoulder for acting as a reaction surface in tightening of the fastening device in use.

6. A fastening device as claimed in claim 5 wherein the sleeve is undercut next to said annular shoulder.
